(19) United States
(12) Patent Application Publication
(10) Pub. No.: US 2026/0038130 A1
(43) Pub. Date: Feb. 5, 2026

(54) Geolocation System

(71) Applicant: Cox Communications, Inc., Atlanta, GA (US)

(72) Inventor: Indra Datta, Atlanta, GA (US)

(21) Appl. No.: 18/792,152

(22) Filed: Aug. 1, 2024

(51) Int. Cl. G06T 7/292; G06T 7/246; G06T 7/73

(52) U.S. Cl. CPC G06T 7/292; G06T 7/248; G06T 7/74; G06T 2207/30208; G06T 2207/30232

(57) ABSTRACT

An example system includes a first imaging device located at a first location and a second imaging device located at a second location; a plurality of markers, wherein each of the plurality of markers corresponds to a known geospatial coordinate; and a controller operably coupled to the plurality of imaging devices, wherein the controller is configured to: receive a first image from a first imaging device, receive a second image from a second imaging device, wherein the second image captures a second marker of the plurality of markers and the object, estimate, based on a first transform, a first object location of an object in the first image, estimate, based on a second transform, a second object location of an object in the second image, and determine that the object in the first image and the second image is the same object.

### BACKGROUND

Monitoring systems often include one or more cameras. Cameras commonly detect two-dimensional images of a scene using two-dimensional sensors (e.g., CCD and CMOS sensors) paired with lenses. The cameras can be located at different locations in an area of interest (e.g., an industrial facility or public space). These two-dimensional images can be watched or recorded for analysis.

There are benefits to improving methods and systems for performing tracking, identification, and/or monitoring using camera systems.

### SUMMARY

In some aspects, the techniques described herein relate to a system including: a plurality of imaging devices including a first imaging device located at a first location and a second imaging device located at a second location; a plurality of markers, wherein each of the plurality of markers corresponds to a known geospatial coordinate; and a controller operably coupled to the plurality of imaging devices, wherein the controller is configured to: receive a first image from the first imaging device, wherein the first image captures a first marker of the plurality of markers and an object; retrieve a first geospatial coordinate of the first marker of the plurality of markers; determine a first transform for relating a position of the first marker of the plurality of markers captured in the first image and its known geospatial coordinate; estimate a first object location of the object based, at least in part, on the first transform and the first geospatial coordinate; receive a second image from the second imaging device, wherein the second image captures a second marker of the plurality of markers and the object; retrieve a second geospatial coordinate of the second marker of the plurality of markers; determine a second transform for relating a position of the second marker of the plurality of markers captured in the second image and its known geospatial coordinate; estimate a second object location of the object based, at least in part, on the second transform and the second geospatial coordinate; and determine, based on the first object location and the second object location, that the object in the first image and the second image is the same object.

In some aspects, the techniques described herein relate to a system, wherein the first and second geospatial coordinates include a latitude and longitude.

In some aspects, the techniques described herein relate to a system, wherein determining that the object in the first image and the second image is the same object includes using multi-valued logic.

In some aspects, the techniques described herein relate to a system, further including estimating a velocity of the first object.

In some aspects, the techniques described herein relate to a system, wherein the first imaging device includes an imaging device configured to move between the first location and a different location.

In some aspects, the techniques described herein relate to a system, wherein the first transform includes a transformation matrix, wherein the transformation matrix includes a mapping of two-dimensional (2d) image coordinates to three-dimensional (3d) real-world coordinates.

In some aspects, the techniques described herein relate to a system, further including displaying a map including the object.

In some aspects, the techniques described herein relate to a system, further including recording a plurality of locations of the object over time.

In some aspects, the techniques described herein relate to a system, further including displaying a heat map of the plurality of locations.

In some aspects, the techniques described herein relate to a system, wherein the plurality of markers are configured so that each of the plurality of imaging devices view at least nine markers of the plurality of markers.

In some aspects, the techniques described herein relate to a computer-implemented method object tracking, the computer-implemented method including: receiving a first image from a first imaging device, wherein the first image captures a first marker of a plurality of markers and an object; retrieving a first geospatial coordinate of the first marker of the plurality of markers; determining a first transform for relating a position of the first marker of the plurality of markers captured in the first image and its known geospatial coordinate; estimating a first object location of the object based, at least in part, on the first transform and the first geospatial coordinate; receiving a second image from the second imaging device, wherein the second image captures a second marker of the plurality of markers and the object; retrieving a second geospatial coordinate of the second marker of the plurality of markers; determining a second transform for relating a position of the second marker of the plurality of markers captured in the second image and its known geospatial coordinate; estimating a second object location of the object based, at least in part, on the second transform and the second geospatial coordinate; and determining, based on the first object location and the second object location, that the object in the first image and the second image is the same object.

In some aspects, the techniques described herein relate to a computer-implemented method, wherein the first and second geospatial coordinates include a latitude and longitude.

In some aspects, the techniques described herein relate to a computer-implemented method, wherein determining that the object in the first image and the second image is the same object includes using multi-valued logic.

In some aspects, the techniques described herein relate to a computer-implemented method, further including estimating a velocity of the first object.

In some aspects, the techniques described herein relate to a computer-implemented method, wherein the first imaging device includes an imaging device configured to move between the first location and a different location.

In some aspects, the techniques described herein relate to a computer-implemented method, wherein the first transform includes a transformation matrix, wherein the transformation matrix includes a mapping of two-dimensional (2d) image coordinates to three-dimensional (3d) real-world coordinates.

In some aspects, the techniques described herein relate to a computer-implemented method, further including displaying a map including the object.

In some aspects, the techniques described herein relate to a computer-implemented method, further including recording a plurality of locations of the object over time.

In some aspects, the techniques described herein relate to a computer-implemented method, further including displaying a heat map of the plurality of locations.

In some aspects, the techniques described herein relate to a computer readable medium having instructions stored therein, wherein execution of the instructions by a processor, causes the processor to: receive a first image from the first imaging device, wherein the first image captures a first marker of the plurality of markers and an object; retrieve a first geospatial coordinate of the first marker of the plurality of markers; determine a first transform for relating a position of the first marker of the plurality of markers captured in the first image and its known geospatial coordinate; estimate a first object location of the object based, at least in part, on the first transform and the first geospatial coordinate; receive a second image from the second imaging device, wherein the second image captures a second marker of the plurality of markers and the object; retrieve a second geospatial coordinate of the second marker of the plurality of markers; determine a second transform for relating a position of the second marker of the plurality of markers captured in the second image and its known geospatial coordinate; estimate a second object location of the object based, at least in part, on the second transform and the second geospatial coordinate; and determine, based on the first object location and the second object location, that the object in the first image and the second image is the same object.

### BRIEF DESCRIPTION OF DRAWINGS

FIG. 1 illustrates an example geolocation system including imaging devices, according to implementations of the present disclosure.

FIG. 2 illustrates an example geolocation system including imaging devices tracking a moving object, according to implementations of the present disclosure.

FIG. 3 illustrates an example display showing example subjects and objects being tracked by an imaging system on a map, according to implementations of the present disclosure.

FIG. 4 illustrates an example display showing the positioning of cameras in the imaging system shown in FIG. 3.

FIGS. 5A and 5B illustrates an example display showing a summary of data recorded by the example imaging system of FIG. 3, according to implementations of the present disclosure.

FIG. 6 illustrates an example computing device.

FIG. 7 illustrates an example method of using homography to track an object, according to implementations of the present disclosure.

### DETAILED DESCRIPTION

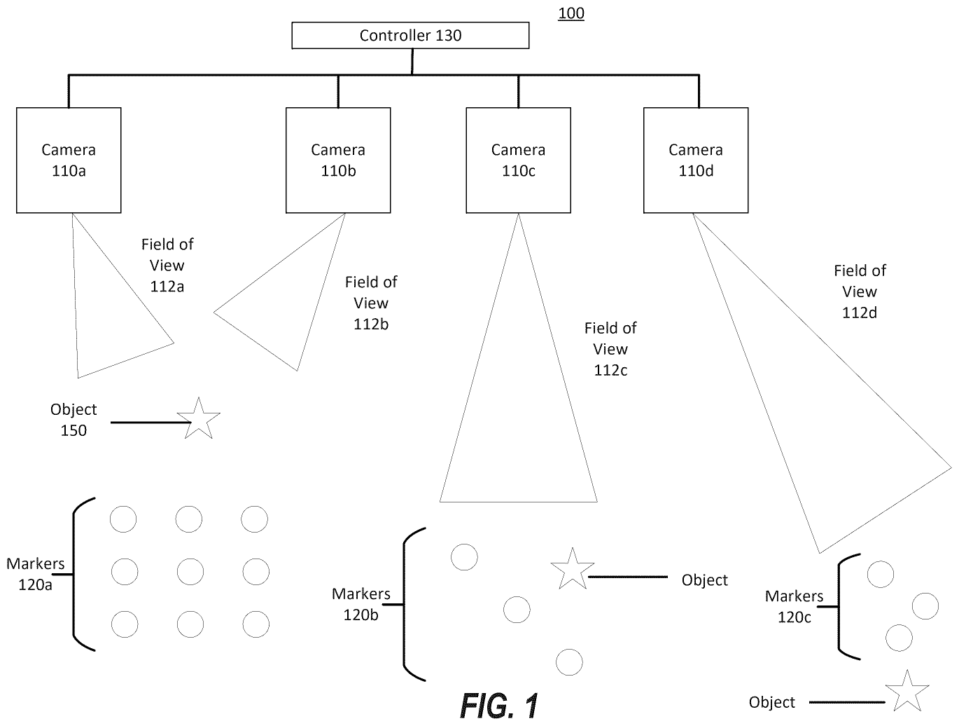

With reference to FIG. 1, an example system 100 is shown according to implementations of the present disclosure.

The system 100 includes a plurality of imaging devices. The present disclosure contemplates that the imaging devices can be any imaging devices, including cameras configured to capture static and/or moving images. For example, as shown in FIG. 1, the system 100 includes cameras 110a, 110b, 110c, 110d. In some implementations, the cameras 110a-110d are coupled to a network, and/or are part of a closed circuit camera system. While four cameras 110a-110d are shown in FIG. 1, implementations of the present disclosure can include any number of cameras. Additionally, it should be understood that the cameras 110a-110d can each have a corresponding field of view 112a-112d. It should be understood that the fields of view 112a-112d can optionally be overlapping (e.g., 112a and 112b), and/or not overlapping (field of view 112c and 112d). It should be understood that any combination of overlapping and not overlapping fields of view is possible for various implementations of the present disclosure.

The cameras 110a-110d can be located at any locations relative to one another. Optionally, each of the cameras 110a-110d can be spaced apart from each other (e.g. on opposite sides of a building or facility) as shown in FIG. 1. However it should be understood that in some implementations any of the cameras 110a-110d can be located at the same location as another camera. For example, two or more of the cameras 110a-110d can be located at the same location (e.g., to provide redundancy or to view different directions from the same location).

In some implementations of the present disclosure, the cameras 110a-110d can be configured so that the position and/or orientation of the cameras 110a-110d is. For example, one or more of the cameras 110a-110d can include motorized mountings (e.g., gimbals or tracks) to change the position and/or orientation of the camera. The present disclosure also contemplates that any or all of the cameras 110a-110d can be located on a mobile computing device, on a vehicle, and/or any other mobile platform.

Still with reference to FIG. 1, the system 100 can include any number of markers 120a 120b 120c. As used herein, a “marker” can be associated with any known location in the field of view 112a-112d of any of the cameras 110a-110d. The known location of a marker or markers can be represented by a geospatial coordinate. As used herein, a geospatial coordinate can include a latitude and/or longitude for any (or every) marker of the markers 120a, 120b, 120c. For example, each of the markers 120a, 120b, 120c can be associated with a respective geospatial coordinate such as a respective latitude and longitude.

It should be understood that the markers can be any items/objects that mark a known location. In some implementations, the markers can be locations that have existing markings and/or objects with known locations. For example, the markers can be locations that are easily visible on a satellite map and/or in the camera views. In an example scene including a soccer field, the markers can optionally be field markings like goal lines and/or corners. As another example, in a scene including light poles, the base of the light pole can be used as a marker. It should be understood that these are non-limiting examples, and that any object or location with a known position can optionally be used as a marker in implementations of the present disclosure. The present disclosure also contemplates that the markers can be lines, symbols, or any other markings that placed in the scene to act as markers, as an alternative or addition to using objects already within the scene.

Optionally, any number of markers 120a-120c can be placed at any number of known locations. For example, nine individual markers are shown in 120a, while three markers are shown for markers 120b and markers 120c. Optionally, the system 100 can be configured so that every camera 110a-110d views at least nine markers. Optionally, any number of markers 120a-120c can be used in the system 100.

Still with reference to FIG. 1, the system 100 can include a controller 130.

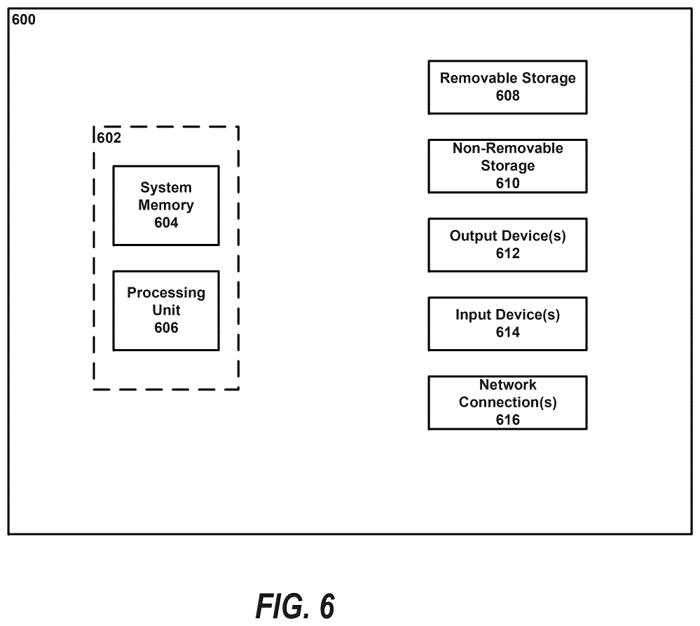

The controller 130 can be operably coupled to any or all of the cameras 110a-110d, for example using one or more communication links. This disclosure contemplates that the communication links are any suitable communication link. For example, a communication link may be implemented by any medium that facilitates data exchange including, but not limited to, wired, wireless and optical links. The controller 130 can include a computing device (e.g., any or all of the components of the computing device 600 shown in FIG. 6).

The controller 130 can optionally be configured to control the cameras 110a-110d. For example, the controller 130 can be configured to cause the cameras 110a-110d to begin recording images or video, to stop recording images or video, and/or to control the position or orientation of the cameras.

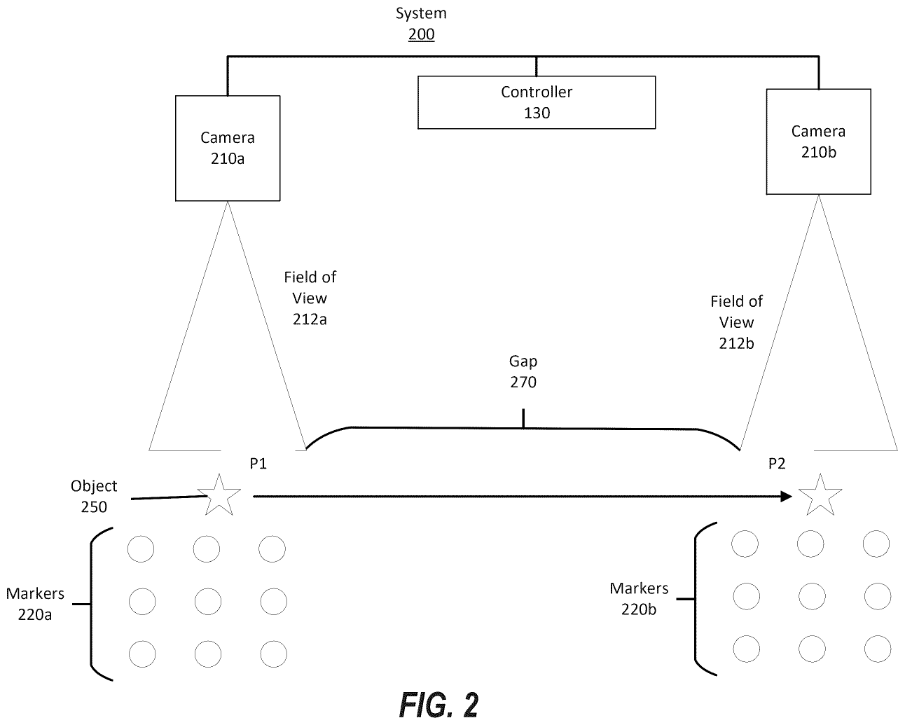

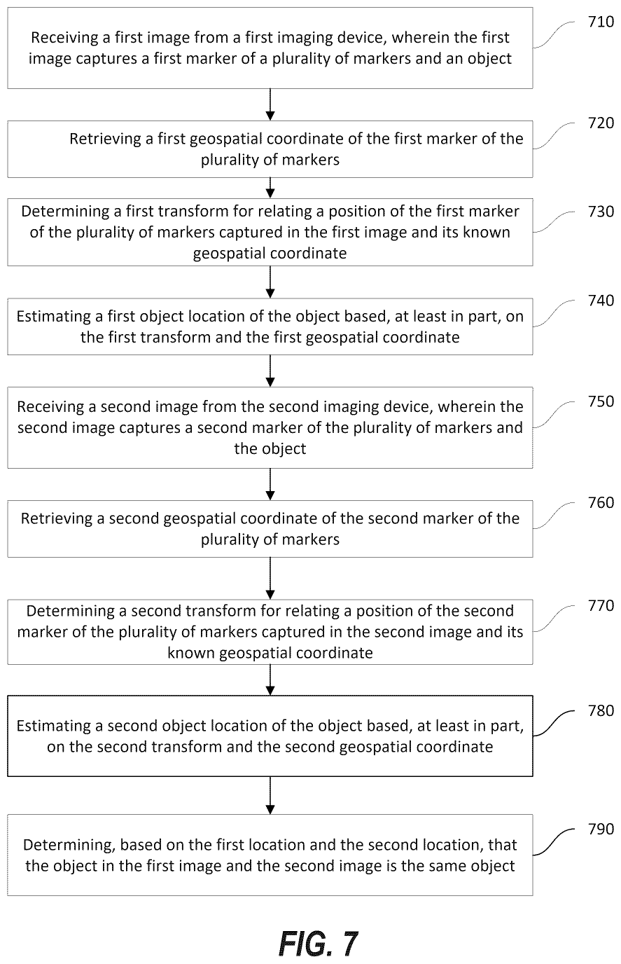

The system 100 can optionally be configured to perform methods of object tracking. As used herein, an “object” or “subject” can be used to refer to any person, animal, and/or inanimate object (e.g., vehicles). Therefore, while implementations are described herein for determining the locations of people and vehicles, for example, implementations of the present disclosure can be used for determining the locations of animals, plants, structures, machinery, etc. With reference to FIG. 7, an example method is shown. In some implementations of the present disclosure, the example method can be performed using a computing device (e.g., the controller 130 shown in FIGS. 1 and 2).

At step 710, the method includes receiving a first image from a first imaging device, where the first image captures a first marker of a plurality of markers and an object. For example, the first imaging device can be camera 110a viewing the markers 120a in FIG. 1.

At step 720, the method includes retrieving a first geospatial coordinate of the first marker of the plurality of markers. As described with reference to FIG. 1, each of the markers 120a can optionally correspond to a known geospatial coordinate of that marker in the world.

At step 730, the method includes determining a first transform of the first marker of the plurality of markers based on the first location of the first imaging device. As used herein, a “transform” includes any relationship between the position of the marker in the image from the first imaging device, and the position of the marker in the world (e.g., the geospatial coordinates of the marker). For example, the transform can relate a position of the first marker captured in the first image and its known geospatial coordinate of the first marker in the first image. The transform can optionally be include a transformation matrix, where the transformation matrix includes a mapping of two-dimensional (2d) image coordinates to three-dimensional (3d) real-world coordinates.

In some implementations of the present disclosure, the transform is a homography transform, which can be represented as a matrix that transforms two planes. A homography transform can be used to determine the location of an unknown point in an image from the first imaging device using the known locations of the markers 120a. In general, a homography transform can include receiving four or more pairs of corresponding points between two images. The points can be on the same real-world plane. Using these points, a homography matrix can be calculated the homography matrix contains the information to map a point from a first image to a corresponding location on the second image. The homography matrix can be applied to any point in the first image to find out where that point would be in the second image.

The homography transforms described herein can be used to deal with changes in perspective, accounting for how objects look different when viewed from different angles (e.g., transforming from one plane to another plane). As a non-limiting example, if the first image is a first picture of a painting, and the second image is a second image of the same painting from a different angle, the two paintings will appear different in the two images due to changes in perspective. Homography transforms allow mapping of points in the first picture to the second picture by defining how the points in the first image can be moved/distorted so that they align with the points in the second image.

The steps of an example homography transform can include, for example:

Selecting at least four pairs of corresponding points (xᵢ, yᵢ) in the first image and (x′ᵢ, y′ᵢ) in the second image. These points can be on the same plane in the real world.

Setting up a system of linear equations based on those points. For example, each pair of corresponding points (xᵢ, yᵢ) and (x′ᵢ, y′ᵢ), can be used to set up two equations:

$${x}_{i}^{′} ( {h}_{31} {x}_{i} + {h}_{32} {y}_{i} + {h}_{31} ) = {h}_{11} {x}_{i} + {h}_{12} {y}_{i} + {h}_{13}$$

$${y}_{i}^{′} ( {h}_{31} {x}_{i} + {h}_{32} {y}_{i} + {h}_{31} ) = {h}_{21} {x}_{i} + {h}_{22} {y}_{i} + {h}_{23}$$

Writing the equations in matrix form: Ah=0 where A is a 2n×9 matrix (for n pairs of points) and h is a 9-element column vector containing the elements of the homography matrix H:

$$A = [ \begin{matrix}{x}_{1} & {y}_{1} & 1 & 0 & 0 & 0 & - {x}_{1}^{′} {x}_{1} & - {x}_{1}^{′} {y}_{1} & - {x}_{1}^{′} \\ 0 & 0 & 0 & {x}_{1} & {y}_{1} & 1 & - {y}_{1}^{′} {x}_{1} & - {y}_{1}^{′} {y}_{1} & - {y}_{1}^{′} \\ {x}_{2} & {y}_{2} & 1 & 0 & 0 & 0 & - {x}_{2}^{′} {x}_{2} & - {x}_{2}^{′} {y}_{2} & - {x}_{2}^{′} \\ 0 & 0 & 0 & {x}_{2} & {y}_{2} & 1 & - {y}_{2}^{′} {x}_{2} & - {y}_{2}^{′} {y}_{2} & - {y}_{2}^{′} \\ ⋮ & ⋮ & ⋮ & ⋮ & ⋮ & ⋮ & ⋮ & ⋮ & ⋮ \\ {x}_{n} & {y}_{n} & 1 & 0 & 0 & 0 & - {x}_{n}^{′} {x}_{n} & - {x}_{n}^{′} {y}_{n} & - {x}_{n}^{′} \\ 0 & 0 & 0 & {x}_{n} & {y}_{n} & 1 & - {y}_{n}^{′} {x}_{n} & - {y}_{n}^{′} {y}_{n} & - {y}_{n}^{′}\end{matrix} ]$$

$$h = [ \begin{matrix}{h}_{11} \\ {h}_{12} \\ {h}_{13} \\ {h}_{21} \\ {h}_{22} \\ {h}_{23} \\ {h}_{31} \\ {h}_{32} \\ {h}_{33}\end{matrix} ]$$

Solving the system Ah=0, using for example, singular value decomposition (SVD). SVD can help find a solution vector h that minimizes the error.

Reshaping the solution into a 3×3 homography matrix, where the homography matrix can be used to transform any point from the first image to its corresponding point in the second image.

The homography transform can be represented by a 3×3 matrix H:

$$H = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ]$$

This matrix maps a point (x, y) in the first image to a point (x′, y′) in the second image by:

$$[ \begin{matrix}{x}^{′} \\ {y}^{′} \\ 1\end{matrix} ] = H [ \begin{matrix}x \\ y \\ 1\end{matrix} ]$$

Where:

$${x}^{′} = \frac{{h}_{11} x + {h}_{12} y + {h}_{13}}{{h}_{31} x + {h}_{32} y + {h}_{33}}$$

$${y}^{′} = \frac{{h}_{21} x + {h}_{22} y + {h}_{23}}{{h}_{31} x + {h}_{32} y + {h}_{33}}$$

Optionally, implementations of the present disclosure are configured so that the field of view 112a of the camera 110a includes at least 9 markers, but it should be understood that different numbers of markers can be visible and/or used in transforms, according to implementations of the present disclosure.

At step 740, the method includes estimating a first location of the object based, at least in part, on the first transform. As described with reference to step 730, the first transform can map the location of the markers 120a to locations in the world (e.g., geospatial coordinates) and thereby estimate the location of an object 150, as shown in FIG. 1.

At step 750, the method includes receiving a second image from a second imaging device, wherein the second image captures a second marker of the plurality of markers and the object. For example, FIG. 1 shows a second camera 110b with a second field of view 112b that includes the object 150.

At step 760, the method includes retrieving a second geospatial coordinate of the second marker of the plurality of markers. Optionally, the second marker can be a different marker or set of markers than the first marker. Alternatively or additionally, the second marker can be the same marker or set of markers. As shown in the example implementation of FIG. 1, the markers 120a can be seen by both the camera 110b and camera 110a.

At step 770, the method includes determining a second transform for relating a position of the second marker of the plurality of markers captured in the second image and its known geospatial coordinate. As described with reference to step 730, the “transform” can include any relationship between the position of the marker in the image and the position of the marker in the world.

At step 780, the method includes estimating a second object location based at least in part, on the second transform and the second geospatial coordinate.

At step 790, the method includes determining, based on the first object location and the second object location, that the object in the first image and the second image is the same object. For example, as shown in FIG. 1, the object 150 is in the fields of view 112a, 112b of both cameras 110a, 110b. Therefore the method can include determining that the location of the object seen by camera 110a is the same as the location of the object seen by camera 110b. Since the objects seen by both cameras have the same location, it can be determined that the objects seen by each camera are actually the same object. Optionally, the method can include using multi-valued logic to account for measurement errors and estimation errors between different cameras when determining that the object 150 seen by each camera 110a, 110b is the same object. A non-limiting example of multi-valued logic that can be used in implementations of the present disclosure is fuzzy logic.

With reference to FIG. 2, the systems described herein can include systems for tracking objects moving between fields of view of different cameras. FIG. 2 illustrates a system 200 including the controller 130 described with reference to FIG. 1, and two cameras 210a, 210b with respective fields of view 212a, 212b. The fields of view 212a, 212b are separated by a gap 270.

An object 250 is illustrated traveling from position P1 to position P2, where P1 is in the field of view 212a of camera 210a, and P2 is in the field of view 212b of camera 210b. As described with reference to FIG. 1, the system 200 can determine the position P1 of the object 250 based on an image from the cameras 210a, 210b including markers 220a. When the object 250 is at P2, the system 200 can determine the position P2 based on an image from the camera 210b and markers 220b. The system 200 can also record (e.g., by the controller 130) the times T1 and T2 that the object is at P1 and P2. Thus, the system can determine a first position and time (P1, T1) and a second position and time (P2, T2) that the object 250 is detected. Based on the pair of positions P1, T1 and P2, T2, the controller 130 can determine an estimated velocity of the object. It should be understood that the same method of estimating a velocity of an object can be performed for an object 250 moving in the field of view of a single camera (e.g., filed of view 212a).

Alternatively or additionally, implementations of the present disclosure can use velocities calculated to determine that the object 250 seen at position P1 is the same object 250 shown at P2. The gap 270 between the field of view 212a and 212b can be a known distance. Therefore in some implementations the velocity of the object 250 can be estimated based on the object's changing position in the field of view 212a, and compared to the velocity of the object seen at P2. If the object velocities are the same or sufficiently similar, then the controller 130 can determine that the object 250 seen at P1 is the same object 250 seen at P2. As a non-limiting example, if the object 250 is a person walking along a path with cameras 210a, 210b located along the path, the first camera 210a can estimate the person's position P1 and velocity V1 based on their movement through the first field of view 212a. As the person walks through a gap 270 between the cameras, the velocity and position of the person is not known. However, the estimated time that the person will take to cross the gap 270 can be estimated based on the velocity V1 (e.g., dividing the distance by the velocity). If the person appears in the field of view 212b in that estimated time, then the controller 130 can predict or determine that the person at P2 is the same person that was walking at P1. Alternatively or additionally, the camera 210b can estimate the velocity of the person across the gap 270 by dividing the distance of the gap by the amount of time that the person was not visible in field of view 212a, 212b.

The present disclosure further contemplates that the methods described herein can combine object recognition models with the systems and methods described herein. For example, the controller 130 can be configured to identify objects by performing image analysis. Non-limiting examples of image analysis can include computer vision and image processing, including trained machine learning models (e.g., neural networks). In implementations including object identification, the controller 130 can be configured to store both the identity of an object and the location of the object in the field of view of one or more cameras over time, so that the object can be tracked as it moves between different cameras of the system.

Optionally, detecting and/or tracking the object between different fields of view can include using multi-valued logic techniques (e.g., fuzzy logic). Fuzzy logic can account for the degree of truth or probability in a value, for example the likelihood that the object seen by one of the cameras of a system is the same as an object seen by any other camera of the system.

In some implementations, the systems and methods described herein can include outputting and displaying any combination of the cameras, fields of view, markers, and/or objects described with reference to FIGS. 1 and 2.

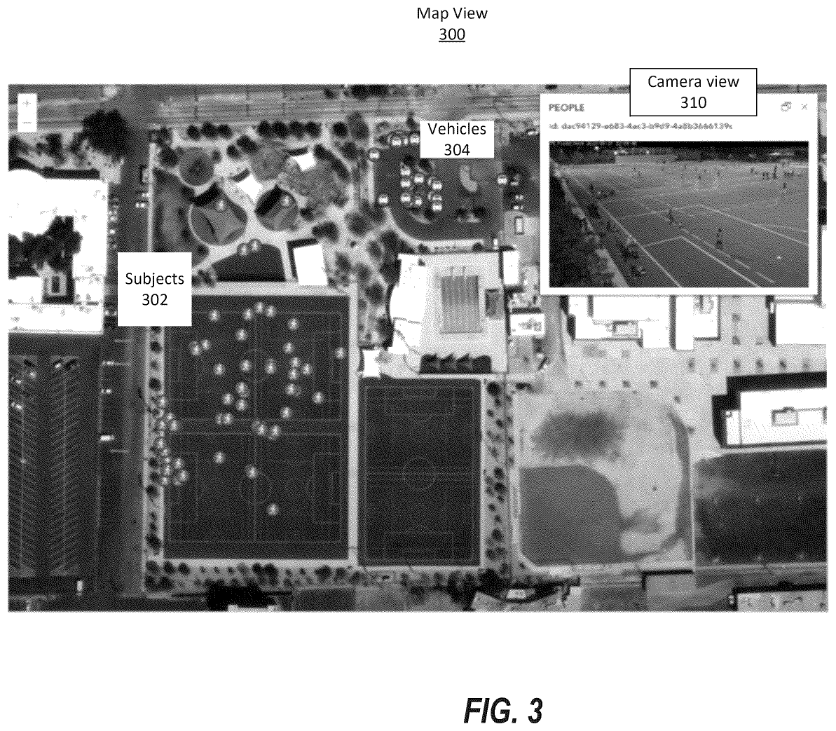

For example, FIG. 3 illustrates a map view 300 according to implementations of the present disclosure. The map view includes a group of subjects 302 and a group of vehicles 304 that have been geolocated and tracked using an example implementation of the present disclosure. The map view 300 can be further configured to include a camera view 310 from any camera in the system. Optionally, the map view 300 can further include a heat map (not shown) including the locations of the subjects 302 and/or vehicles 304 over a time period, based on how many subjects 302 and/or vehicles have been in different locations over that time period.

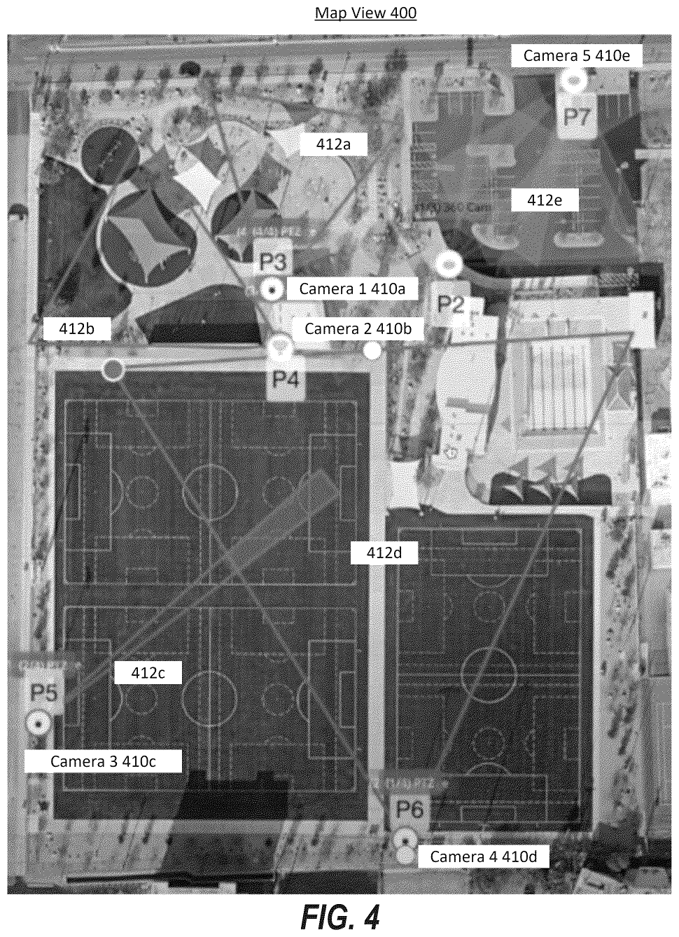

With reference to FIG. 4, the systems and methods described herein can further include outputting a map view 400 including the fields of views of cameras in a system. Cameras 410a, 410b, 410c, 410d, 410e are shown with corresponding fields of view 412a, 412b, 412c, 412d, 412e.

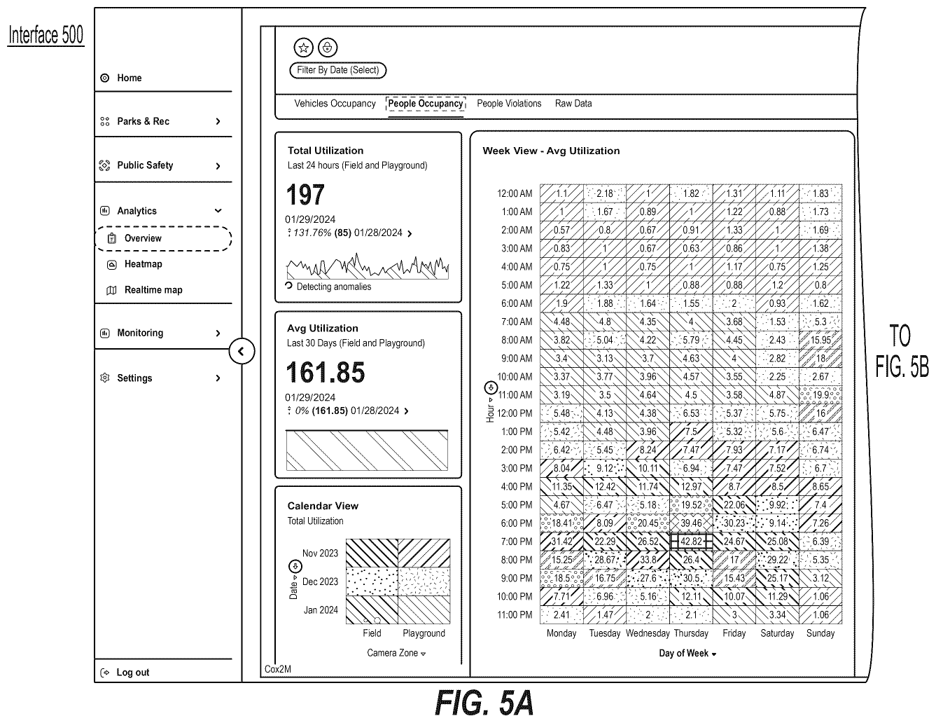

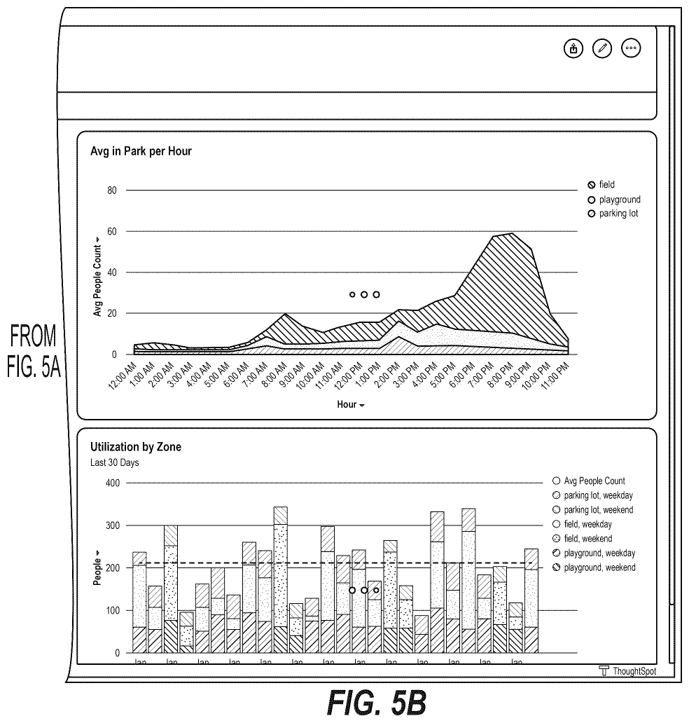

With reference to FIGS. 5A and 5B, the systems and methods described herein can further include recording and tracking the locations of objects over time and generating summaries of that data. An example interface 500 shown in FIG. 5A and FIG. 5B summarizes the number of visitors to a location, the number of visitors in different area of that location, and the changes in visitors over time. It should be understood that the interface 500 shown in FIGS. 5A and 5B is a non-limiting example, and that any of the data described herein can be displayed using any interface.

Referring to FIG. 6, an example computing device 600 upon which the methods described herein may be implemented is illustrated. It should be understood that the example computing device 600 is only one example of a suitable computing environment upon which the methods described herein may be implemented. Optionally, the computing device 600 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 3 by dashed line 602. The processing unit 606 may be a standard programmable processor that performs arithmetic and logic operations necessary for operation of the computing device 600. The computing device 600 may also include a bus or other communication mechanism for communicating information among various components of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 606 for execution. Example tangible, computer-readable media may include, but is not limited to, volatile media, non-volatile media, removable media and non-removable media implemented in any method or technology for storage of information such as computer readable instructions, data structures, program modules or other data. System memory 604, removable storage 608, and non-removable storage 610 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

1. A system comprising:
a plurality of imaging devices comprising a first imaging device located at a first location and a second imaging device located at a second location;
a plurality of markers, wherein each of the plurality of markers corresponds to a known geospatial coordinate; and
a controller operably coupled to the plurality of imaging devices, wherein the controller is configured to:
receive a first image from the first imaging device, wherein the first image captures a first marker of the plurality of markers and an object;
retrieve a first geospatial coordinate of the first marker of the plurality of markers;
determine a first transform for relating a position of the first marker of the plurality of markers captured in the first image and its known geospatial coordinate;
estimate a first object location of the object based, at least in part, on the first transform and the first geospatial coordinate;
receive a second image from the second imaging device, wherein the second image captures a second marker of the plurality of markers and the object;
retrieve a second geospatial coordinate of the second marker of the plurality of markers;
determine a second transform for relating a position of the second marker of the plurality of markers captured in the second image and its known geospatial coordinate;
estimate a second object location of the object based, at least in part, on the second transform and the second geospatial coordinate; and
determine, based on the first object location and the second object location, that the object in the first image and the second image is the same object.

2. The system of claim 1, wherein the first and second geospatial coordinates comprise a latitude and longitude.

3. The system of claim 1, wherein determining that the object in the first image and the second image is the same object comprises using multi-valued logic.

4. The system of claim 1, further comprising estimating a velocity of the first object.

5. The system of claim 1, wherein the first imaging device comprises an imaging device configured to move between the first location and a different location.

6. The system of claim 1, wherein the first transform comprises a transformation matrix, wherein the transformation matrix comprises a mapping of two-dimensional (2d) image coordinates to three-dimensional (3d) real-world coordinates.

7. The system of claim 1, further comprising displaying a map including the object.

8. The system of claim 1, further comprising recording a plurality of locations of the object over time.

9. The system of claim 8, further comprising displaying a heat map of the plurality of locations.

10. The system of claim 1, wherein the plurality of markers are configured so that each of the plurality of imaging devices view at least nine markers of the plurality of markers.

11. A computer-implemented method object tracking, the computer-implemented method comprising:
receiving a first image from a first imaging device, wherein the first image captures a first marker of a plurality of markers and an object;
retrieving a first geospatial coordinate of the first marker of the plurality of markers;
determining a first transform for relating a position of the first marker of the plurality of markers captured in the first image and its known geospatial coordinate;
estimating a first object location of the object based, at least in part, on the first transform and the first geospatial coordinate;
receiving a second image from the second imaging device, wherein the second image captures a second marker of the plurality of markers and the object;
retrieving a second geospatial coordinate of the second marker of the plurality of markers;
determining a second transform for relating a position of the second marker of the plurality of markers captured in the second image and its known geospatial coordinate;
estimating a second object location of the object based, at least in part, on the second transform and the second geospatial coordinate; and
determining, based on the first object location and the second object location, that the object in the first image and the second image is the same object.

12. The computer-implemented method of claim 11, wherein the first and second geospatial coordinates comprise a latitude and longitude.

13. The computer-implemented method of claim 11, wherein determining that the object in the first image and the second image is the same object comprises using multi-valued logic.

14. The computer-implemented method of claim 11, further comprising estimating a velocity of the first object.

15. The computer-implemented method of claim 11, wherein the first imaging device comprises an imaging device configured to move between the first location and a different location.

16. The computer-implemented method of claim 11, wherein the first transform comprises a transformation matrix, wherein the transformation matrix comprises a mapping of two-dimensional (2d) image coordinates to three-dimensional (3d) real-world coordinates.

17. The computer-implemented method of claim 11, further comprising displaying a map including the object.

18. The computer-implemented method of claim 11, further comprising recording a plurality of locations of the object over time.

19. The computer-implemented method of claim 18, further comprising displaying a heat map of the plurality of locations.

20. A computer readable medium having instructions stored therein, wherein execution of the instructions by a processor, causes the processor to:
receive a first image from a first imaging device, wherein the first image captures a first marker of a plurality of markers and an object;
retrieve a first geospatial coordinate of the first marker of the plurality of markers;
determine a first transform for relating a position of the first marker of the plurality of markers captured in the first image and its known geospatial coordinate;
estimate a first object location of the object based, at least in part, on the first transform and the first geospatial coordinate;
receive a second image from the second imaging device, wherein the second image captures a second marker of the plurality of markers and the object;
retrieve a second geospatial coordinate of the second marker of the plurality of markers;
determine a second transform for relating a position of the second marker of the plurality of markers captured in the second image and its known geospatial coordinate;
estimate a second object location of the object based, at least in part, on the second transform and the second geospatial coordinate; and
determine, based on the first object location and the second object location, that the object in the first image and the second image is the same object.
